(19) United States
(12) Patent Application Publication
(10) Pub. No.: US 2017/0369290 A1
(43) Pub. Date: Dec. 28, 2017

(54) Self-contained Automatic Jack

(71) Applicant: Double K Technologies, Inc., Sutherland, NE (US)

(72) Inventor: Dan Kennicutt, Sutherland, NE (US)

(21) Appl. No.: 15/192,990

(22) Filed: Jun. 24, 2016

(51) Int. Cl. B66F 3/24; B66F 3/42

(52) U.S. Cl. CPC B66F 3/24; B66F 3/42

(57) ABSTRACT

A self-contained electric double-acting hydraulic cylinder jack for lifting objects is provided, comprising a vertically elongated upper housing section and lower housing section, which are slidably assembled on each other to form a self-contained assembly, a hydraulic electric linear actuator placed between the upper housing and lower housing sections, which actuator comprises an integrated motor, pump, valve, and double-acting cylinder, an on-board battery for supplying power to the hydraulic electric linear actuator, and a momentary on-off-on toggle switch conjugated in electrical connection with the battery to actuate the actuator.

### FIELD OF THE INVENTION

The present invention relates to electric jacks for lifting objects.

### BACKGROUND OF THE INVENTION

In the field of vertically adjustable support mechanisms for lifting, there are a variety of devices commonly referred to as jacks. Jacks are most commonly used to lift vehicles from the ground in order to repair or perform maintenance upon them. Perhaps the most common type of jack is a hydraulic cylinder jack, which provides, through pressurized hydraulic fluid, linear motion with high force. Hydraulic cylinder jacks may be single-acting or double-acting. Most commercial hydraulic cylinder jacks are double-acting. A double-acting hydraulic cylinder jack includes a cylinder with top port and bottom port, a piston, a piston rod, and a hydraulic fluid control circuit connected to the cylinder through the top and bottom ports. The control circuit comprises a pump, a control valve, and a hydraulic fluid. The hydraulic fluid is pumped from through the bottom port to extend the piston up through the cylinder, and through the top port to lower the piston. The control valve ensures that hydraulic fluid is not pumped into both ports at once. The pump is driven by hand, air, electric motor, or gas engine.

In the case of a double-acting hydraulic cylinder jack where the pump is driven by an electric motor, the jack must be connected to an external power supply through a cable, which can be cumbersome to the user. What is needed, therefore, is an electric double-acting hydraulic cylinder jack in which the power supply is introduced in a self-contained operating mode and does not rely on an external power source to drive it.

### SUMMARY OF THE INVENTION

The present invention provides a self-contained electric double-acting hydraulic cylinder jack comprising a vertically elongated upper housing section and lower housing section, which are slidably assembled on each other to form a self-contained assembly, a hydraulic electric linear actuator placed between the upper housing and lower housing sections, which actuator comprises an integrated motor, pump, valve, and double-acting cylinder, an on-board battery for supplying power to the hydraulic electric linear actuator, and a momentary on-off-on toggle switch conjugated in electrical connection with the battery to actuate the actuator.

The main object of the invention is to eliminate the need for an external power source for an electric double-acting hydraulic cylinder jack. Other objects and advantages of the invention inherent to it will become apparent upon a perusal of this specification.

### BRIEF DESCRIPTION OF THE DRAWINGS

The invention will be described with reference to the following drawings of which:

FIG. 1 is an enlarged, fragmentary elevational view of a self-contained electric double-acting hydraulic cylinder jack on which embodiments of the present invention may be employed;

FIG. 2a is isometric upper housing section of proposed jack;

FIG. 2b is exploded upper housing section of proposed jack;

FIG. 3a is isometric lower housing section of proposed jack; and

FIG. 3b is exploded lower housing section of proposed jack.

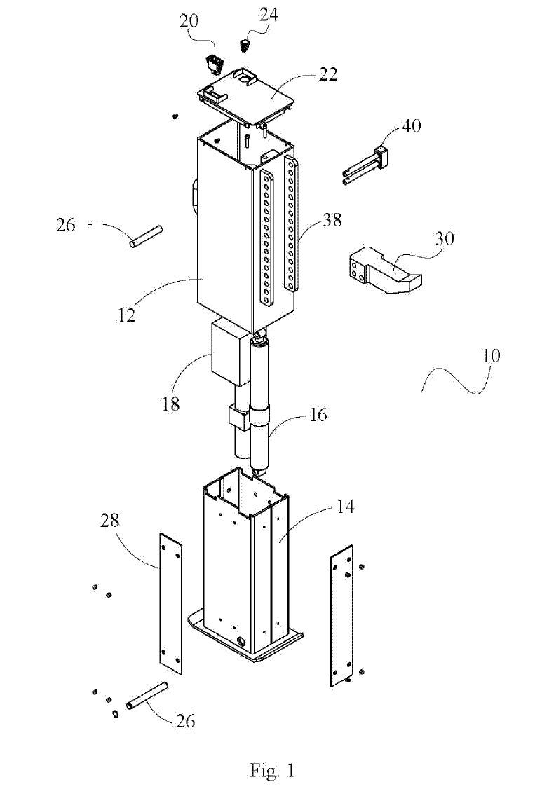

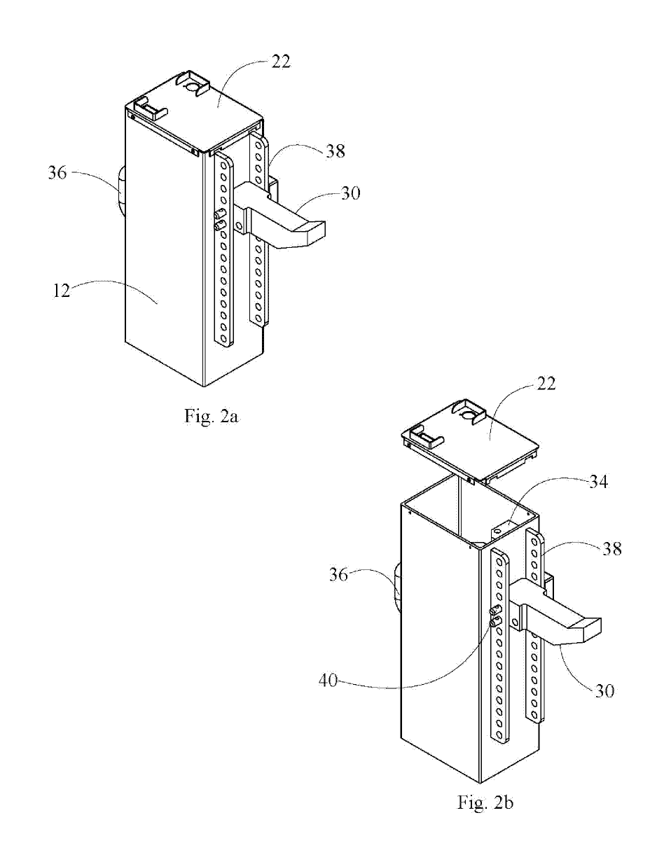

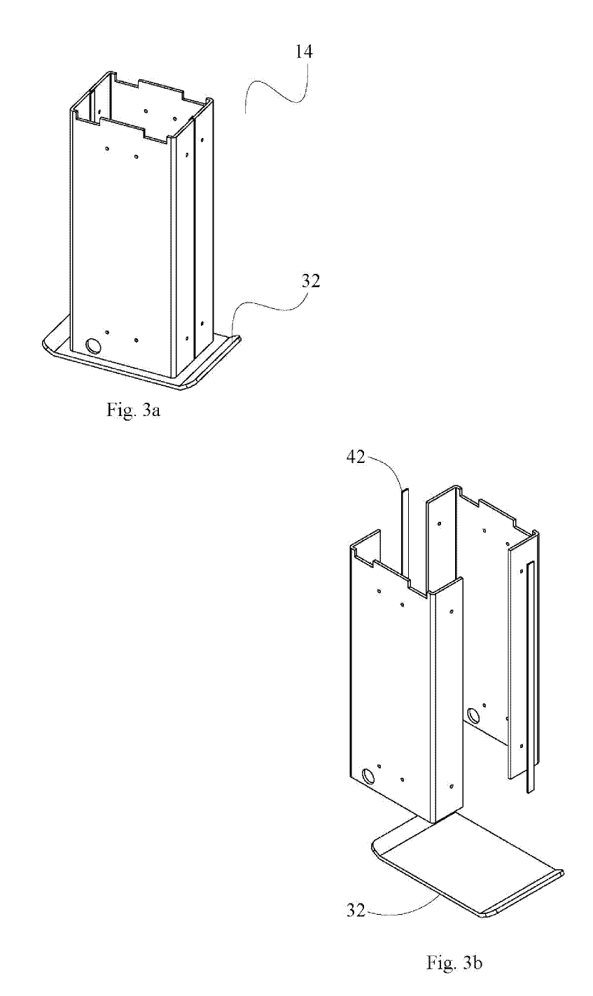

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE INVENTION

The following detailed description of embodiments of the invention references the accompanying drawings. The embodiments are intended to describe aspects of the invention in sufficient detail to enable those skilled in the art to practice the invention. Other embodiments can be utilized and changes can be made without departing from the scope of the claims. The following detailed description is, therefore, not to be taken in a limiting sense. The scope of the present invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

Described herein is a self-contained electric double-acting hydraulic cylinder jack comprising a vertically elongated upper housing section and lower housing section, which are slidably assembled on each other to form a self-contained assembly, a hydraulic electric linear actuator placed between the upper housing and lower housing sections, which actuator comprises an integrated DC motor, pump, valve, and double-acting hydraulic cylinder having a first end and second end, an on-board rechargeable 12V battery connected to the actuator for supplying power to the actuator, and a momentary on-off-on toggle switch conjugated in electrical connection with the on-board battery to actuate the actuator up and down. An electrical connector is provided for charging the on-board battery through an external power supply. The actuator is vertically mounted within the housing assembly, with one end fixed to the upper housing section and the opposite end fixed to the lower housing section.

With reference to the figures, the self-contained electric double-acting hydraulic cylinder jack 10 of the present invention comprises a vertically elongated upper housing section 12 and lower housing section 14, which are slidably assembled on each other to form a self-contained assembly. A hydraulic electric linear actuator 16 is placed between the upper housing section 12 with cover 22 and the lower housing section 14. The hydraulic electric linear actuator 16 comprises an an integrated DC motor, pump, valve, and double-acting hydraulic cylinder having a first end and second end. A 12V rechargeable battery 18 is attached to and supplies power to the actuator. In electrical connection with the battery 18, a momentary on-off-on toggle switch 20 actuates the actuator for lifting and lowering vehicles or other objects. The battery 18 is recharged by an external power supply via an electrical connector 24. The first end of the hydraulic double-acting cylinder of the actuator 16 is fixed to the upper housing section 12 by way of a cylinder mount 34 fixed to the interior of the upper housing section and a pin 26. The second end of the hydraulic double-acting cylinder of the actuator 16 is fixed to the lower housing section by a pin 26. To maintain good friction between moving parts while lifting and lowering, wear pads 28 are mounted on each side of the lower housing section 14. A lifting arm 30 is attached to the upper housing section 12 with pin racks 38 having well gapped holes, which accommodate the lifting arm 30 by means of a pin assembly 40 adjustable in various vertical configurations. A handle 36 located on the upper housing section 12 facilitates easy handing. The lower housing section 14 includes a base 32 which enables the whole assembly to rest on ground uniformly. Two half tube partitions jointly form the lower housing section 14 and are joined together onto the base 32. Small plates 42 are placed inside to give more rigidity and structural strength to the lower housing section 14.

In a preferred embodiment, hydraulic electric linear actuator 16 is the MINI-MOTION PACKAGE™ marketed by KYB America, LLC.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

The Abstract of the disclosure will allow the reader to quickly ascertain the nature of the technical disclosure. It is submitted with the understanding that it will not be used to interpret or limit the scope or meaning of the following claims.

What is claimed is:

1. A self-contained electric double-acting hydraulic cylinder jack comprising a vertically elongated upper housing section and lower housing section, which are slidably assembled on each other to form a self-contained assembly, a hydraulic electric linear actuator placed between and fixed to the upper housing and lower housing sections, which actuator comprises an integrated DC motor, pump, valve, and double-acting hydraulic cylinder having a first end and second end, an on-board rechargeable 12V battery connected to the actuator for supplying power to the actuator, and a momentary on-off-on toggle switch conjugated in electrical connection with the on-board battery to actuate the actuator.
